(19) United States
(12) Patent Application Publication
(10) Pub. No.: US 2012/0293989 A1
(43) Pub. Date: Nov. 22, 2012

(54) LIGHTING DEVICE WITH A LIQUID EJECTION FUNCTION

(76) Inventors: Qiang-Fei Duan, New Taipei City (TW); Bin-Bin Duan, New Taipei City (TW)

(21) Appl. No.: 13/113,066

(22) Filed: May 22, 2011

(51) Int. Cl. F21V 29/00

(52) U.S. Cl. 362/218

(57) ABSTRACT

A lighting device includes a first cover, a heat dissipating structure, and a lightbar device. A plurality of first guide slots is formed on the first cover. The heat dissipating structure is disposed in the first cover and has a plurality of heat dissipating fins. A plurality of second guide slots is formed on positions between adjacent heat dissipating fins respectively corresponding to the plurality of first guide slots. The lightbar device is disposed on the heat dissipating structure. Light generated by the lightbar device is emitted out of the first cover. Liquid is drained out through at least one of the plurality of first guide slots and the corresponding second guide slot.

### BACKGROUND OF THE INVENTION

1. Field of the Invention

The present invention relates to a lighting device, and more specifically, to a lighting device with a liquid ejection function.

2. Description of the Prior Art

In general, outdoor illumination is one of main applications of a conventional lighting device. For preventing liquid (e.g. rainwater) from entering the lighting device via its heat dissipating hole or structure gap to cause short circuit, the lighting device usually has a waterproof function by a sealing structural design, so as to ensure that the circuit devices in the lighting device can work properly. Accordingly, the lighting device can keep illuminating in an outdoor environment. However, the said sealing structural design obstructs air convection between the lighting device and the outdoor environment, so as to make heat generated by light emitting diodes in the lighting device incapable of being dissipated efficiently. As a result, life of the lighting device is reduced greatly due to the internal temperature increase. On the other hand, the lighting device does not have a water ejection function. Thus, after the lighting device is used over a period of time, water may accumulate in the lighting device to make the internal structures of the lighting device become rusty easily. The said condition also reduces life of the lighting device. Furthermore, for a conventional lighting device with heat dissipating fins which are exposed outside, dust and rainwater can not be expelled quickly, but accumulate over the dissipating fins so as to reduce heat dissipating efficiency of the heating dissipating fins greatly. In such a manner, the internal temperature of the lighting device is raised easily, and then life of the lighting device is further influenced.

### SUMMARY OF THE INVENTION

The present invention provides a lighting device with a liquid ejection function. The lighting device includes a first cover, a heat dissipating structure, and a lightbar device. A plurality of first guide slots is formed on the first cover. The heat dissipating structure is disposed in the first cover and has a plurality of heat dissipating fins. A plurality of second guide slots is formed on positions between adjacent heat dissipating fins respectively corresponding to the plurality of first guide slots. The lightbar device is disposed on the heat dissipating structure. Light generated by the lightbar device is emitted out of the first cover. Liquid is drained out through at least one of the plurality of first guide slots and the corresponding second guide slot.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a lighting device according to an embodiment of the present invention.

FIG. 2 is a diagram of the lighting device in FIG. 1 at another view angle.

FIG. 3 is an enlarged diagram of a first cover in FIG. 1.

FIG. 4 is an enlarged diagram of a second cover in FIG. 1.

FIG. 5 is an enlarged diagram of a heat dissipating structure in FIG. 2 having a lightbar device disposed thereon.

FIG. 6 is an enlarged diagram of the heat dissipating structure in FIG. 5 at another view angle.

### DETAILED DESCRIPTION

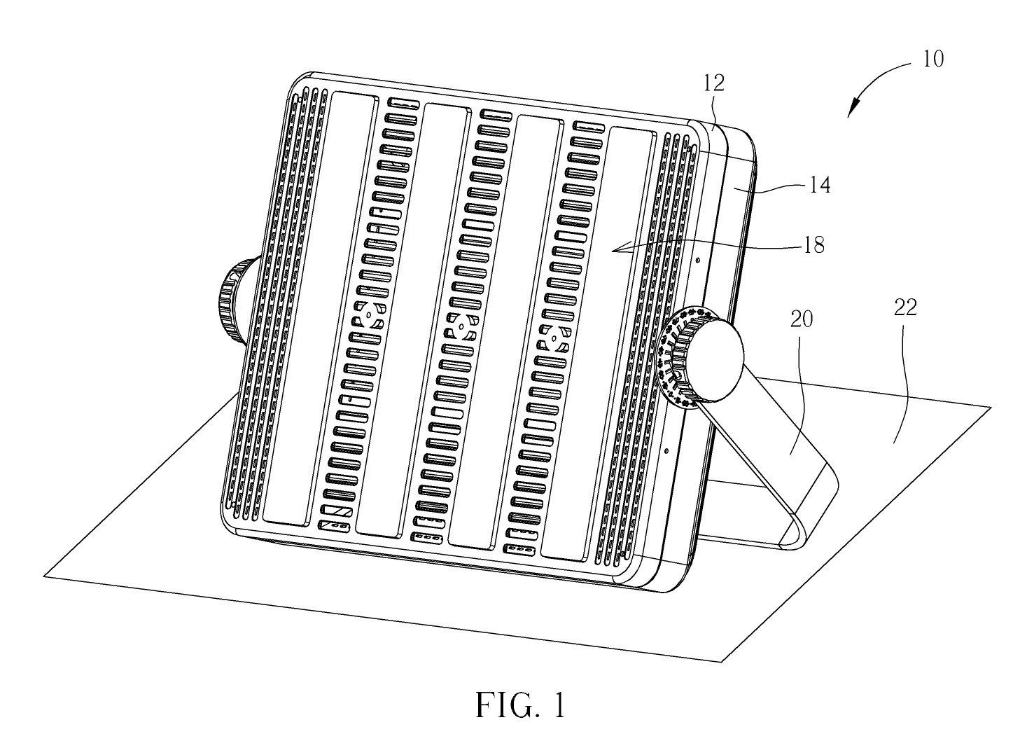

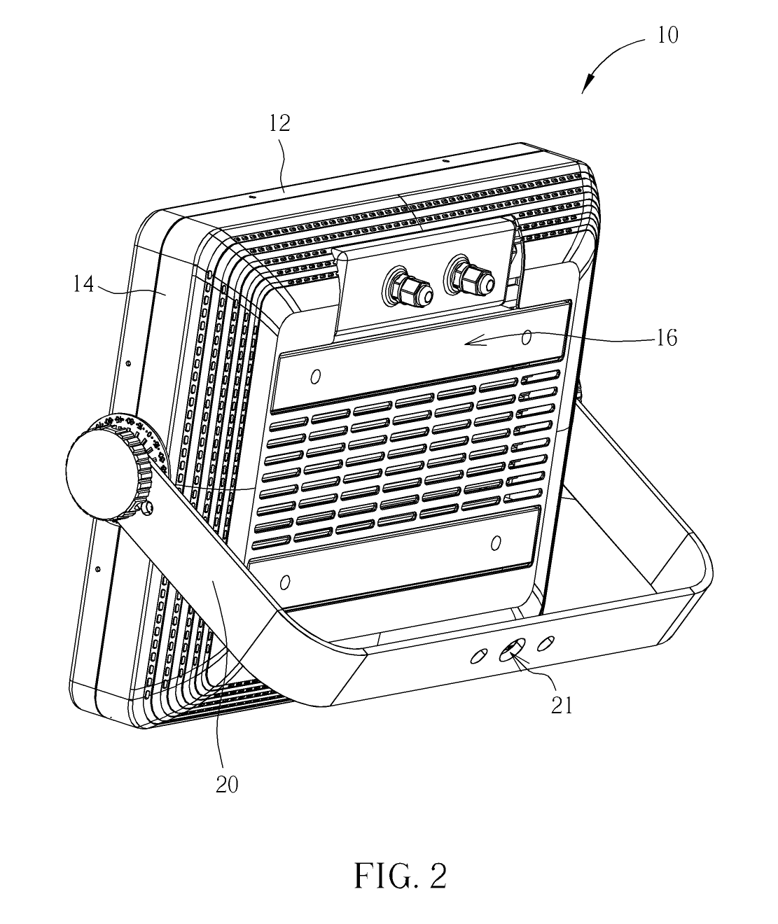

Please refer to FIG. 1 and FIG. 2. FIG. 1 is a diagram of a lighting device 10 according to an embodiment of the present invention. FIG. 2 is a diagram of the lighting device 10 in FIG. 1 at another view angle. As shown in FIG. 1 and FIG. 2, the lighting device 10 includes a first cover 12, a second cover 14, a heat dissipating structure 16, a lightbar device 18, and a support frame 20. The second cover 14 is connected to a side of the first cover 12 for covering the heat dissipating structure 16 and the lightbar device 18 cooperatively with the first cover 12. In this embodiment, the support frame 20 is pivotally connected to the first cover 12 for supporting the first cover 12 and the second cover 14 on a holding surface 22, but is not limited thereto. That is, the support frame 20 can be pivotally connected to the second cover 14 instead. In such a manner, the lighting device 10 can emit light at a specific angle when being disposed on the holding surface 22. Furthermore, as shown in FIG. 2, the support frame 20 has at least one screw hole 21 (three shown in FIG. 2) for engaging with a fixing screw, so that the support frame 20 can be fixed onto a support wall in a screw locking manner to make the lighting device 10 hung on the support wall.

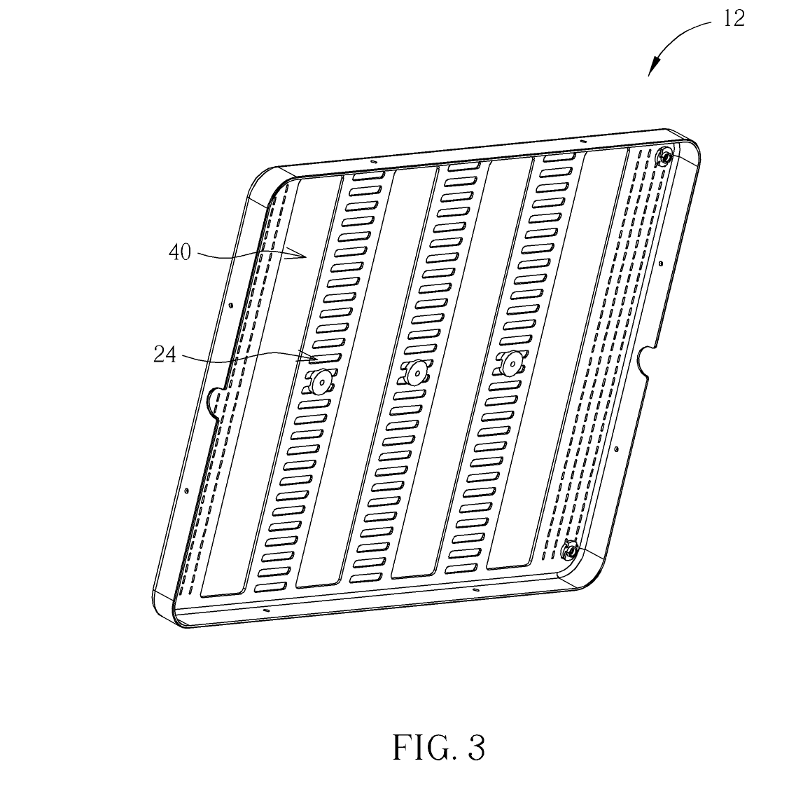

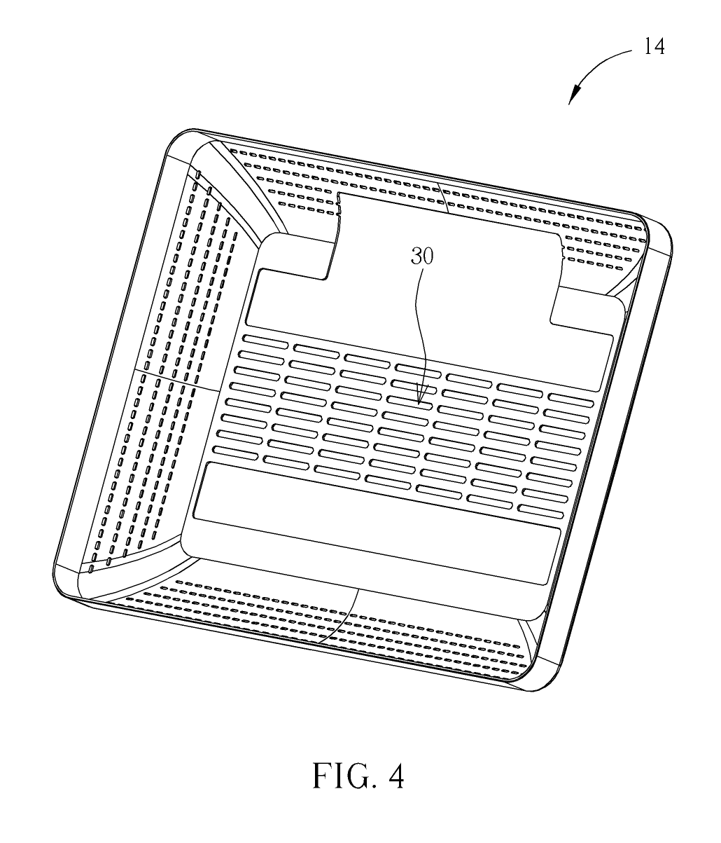

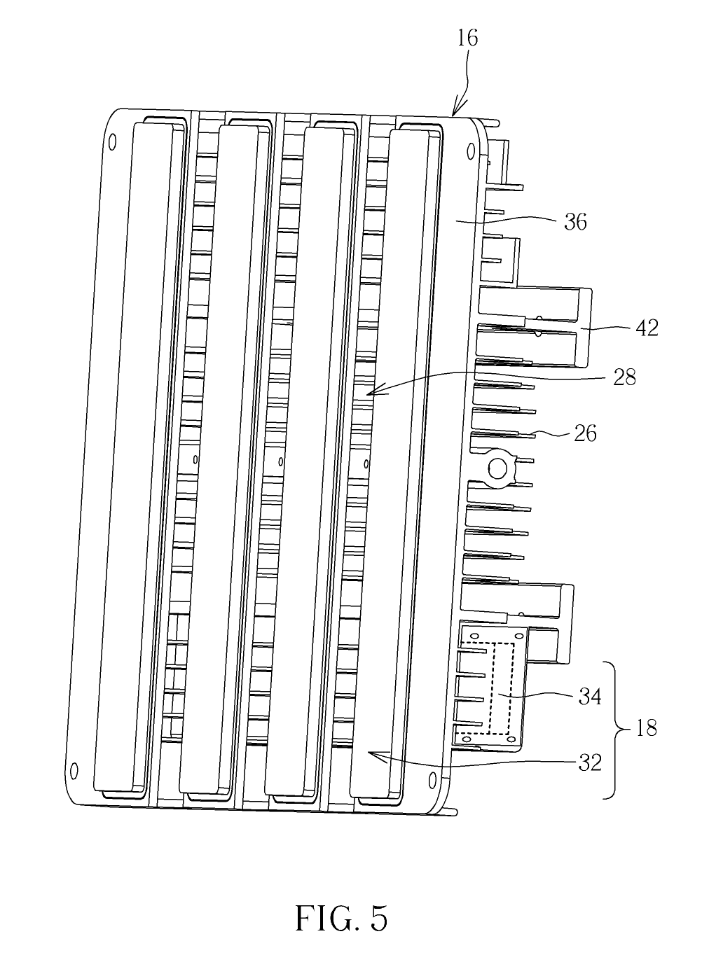

More detailed description for the structural design of the components of the lighting device 10 is provided as follows. Please refer to FIG. 3, FIG. 4, and FIG. 5. FIG. 3 is an enlarged diagram of the first cover 12 in FIG. 1. FIG. 4 is an enlarged diagram of the second cover 14 in FIG. 1. FIG. 5 is an enlarged diagram of the heat dissipating structure 16 in FIG. 2 having the lightbar device 18 disposed thereon. As shown in FIG. 3, FIG. 4, and FIG. 5, a plurality of first guide slots 24 is formed on the first cover 12, and the heat dissipating structure 16 is disposed in the first cover 12 and the second cover 14 and has a plurality of heat dissipating fins 26. The heat dissipating structure 16 is preferably formed by an aluminum extrusion process. A plurality of second guide slots 28 is formed on positions between adjacent heat dissipating fins 26 respectively corresponding to the plurality of first guide slots 24. A plurality of third guide slots 30 is formed at positions of the second cover 14 corresponding to the plurality of second guide slots 28. The lightbar device 18 is disposed on the heat dissipating structure 16 for utilizing the heat-dissipating fins 26 to dissipate heat generated during the lightbar device 18 emits light. The lightbar device 18 includes at least one lightbar 32 (four shown in FIG. 5) and a control circuit board 34. The lightbar 32 is disposed on a front surface 36 of the heat dissipating structure 16. In this embodiment, the lightbar 32 includes a plurality of light emitting diodes, but is not limited thereto. That is, the lightbar 32 can also adopt other type of light emitting component, such as a cold cathode fluorescent lamp. The control circuit board 34 is electrically connected to the lightbar 32 and disposed in a sealing chamber 38 of the heat dissipating structure 16 for waterproof, so as to prevent the liquid entering the lighting device 10 from contacting the control circuit board 34. Furthermore, as shown in FIG. 1 and FIG. 3, in this embodiment, the lightbar 32 protrudes from a light exit opening 40 of the first cover 12 so as to make light generated by the lightbar 32 capable of emitting out of the first cover 12 for illumination.

In the following, the liquid ejection design of the lighting device 10 is described in detail on condition that the lighting device 10 is applied to outdoor illumination. When liquid (e.g. rainwater) falls on the lighting device 10 during the lighting device 10 is used, the liquid flows from the surface of the first cover 12 to at least one of the first guide slots 24 and then enters the lighting device 10 via the first guide slot 24. Subsequently, since the second guide slots 28 and the third guide slots 30 are formed on the heat dissipating structure 16 and the second cover 14 respectively as mentioned above, the said liquid flows through the corresponding second guide slot 28 and the corresponding third guide slot 30 sequentially and then is drained out of the second cover 14. In brief, via the flow guide design of the first guide slot 24, the second guide slot 28, and the third guide slot 30, the liquid that enters the lighting device 10 can be drained out of the lighting device 10 quickly. Thus, the present invention can prevent the liquid from continuously accumulating in the lighting device, as well as prevent the components in the lighting device 10 from becoming rusty due to the accumulated liquid, so as to prolong life of the lighting device 10. In practical application, for making the liquid be drained out more efficiently, at least one liquid outlet (not shown in figures) is selectively formed at the bottom side of the first cover 12 or the second cover 14 for guiding draining out of the liquid.

Besides the said liquid ejection function, the lighting device 10 can also have a function of expelling small objects (e.g. dust). That is, a small object can also be expelled out of the lighting device 10 after passing through the first guide slot 24, the second guide slot 28, and the third guide slot 30 sequentially. Thus, the problem that small objects accumulate in the lighting device 10 after the lighting device 10 is used over a period of time can be solved. Furthermore, the lighting device 10 can further have a heating dissipating function by the first guide slot 24 and the third guide slot 30 respectively formed on the first cover 12 and the second cover 14, meaning that the heat dissipating structure 16 can dissipate heat generated during the lighting device 10 emits light cooperatively with the first guide slot 24 and the third guide slot 30.

To be noted, in another embodiment, a guide channel (not shown in figures) is extendedly formed on the first guide slot 24 or the second guide slot 28. The guide channel is communicated with the corresponding first guide slot 24 and the corresponding second guide slot 28 for guiding the flow of the liquid. In such a manner, the liquid can flow from the first guide slot 24 to the corresponding second guide slot 28 more efficiently so as to enhance liquid ejection efficiency of the lighting device 10. The said guide channel can also be formed the second guide slot 28 or the third guide slot 30 for communicating with the second guide slot 28 and the third guide slot 30.

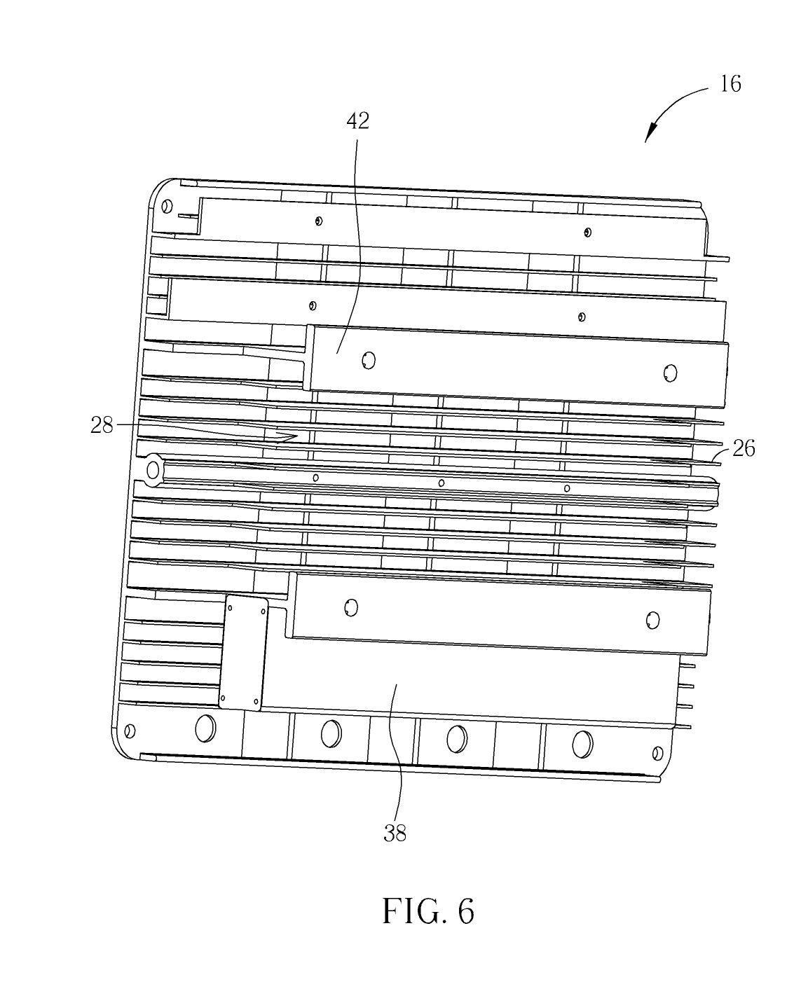

Furthermore, disposal of the lighting device 10 is not limited to the design of utilizing the support frame 20 to support the first cover 12 and the second cover 14 on the holding surface 22 mentioned in the said embodiment. That is, the support frame 20 can be an omissible component. For example, please refer to FIG. 6, which is an enlarged diagram of the heat dissipating structure 16 in FIG. 5 at another view angle. As shown in FIG. 6, the heat dissipating structure 16 further has at least one engaging member 42 (two shown in FIG. 6). The engaging member 42 can protrude from the second cover 14 by elongating its length. In such a manner, the engaging member 42 can be used for engaging with a corresponding engaging structure on a support wall so as to hang the lighting device 10 onto the support wall. The engaging member 42 is preferably a T-shaped structure, but is not limited thereto. It should be mentioned that the engaging member 42 can be disposed on the second cover 14 instead of directly being formed on the heat dissipating structure 16. As for which design is utilized, it depends on the practical application of the lighting device 10. Furthermore, the second cover 14 can also be an omissible component for simplifying the structural design and assembly process of the lighting device 10. In other words, the lighting device 10 can only utilize the first cover 12 to cover the heat dissipating structure 16.

Compared with the prior art, the present invention utilizes the design that both of the cover and the heat dissipating structure have the corresponding guide slots formed thereon, so that liquid can be drained out of the lighting device after passing through the corresponding guide slots sequentially. In such a manner, the lighting device provided by the present invention can not only prevent that liquid (or small objects) accumulates therein and then reduces heat dissipating efficiency of the lighting device, but also solve the problem that the components in the lighting device become rusty easily due to the accumulated liquid. Accordingly, life of the lighting device can be enhanced. Furthermore, the heat dissipating structure can also dissipate heat generated during the lighting device emits light cooperatively with the guide slots.

Those skilled in the art will readily observe that numerous modifications and alterations of the device and method may be made while retaining the teachings of the invention.

What is claimed is:

1. A lighting device with a liquid ejection function, the lighting device comprising:
a first cover, a plurality of first guide slots being formed on the first cover;
a heat dissipating structure disposed in the first cover and having a plurality of heat dissipating fins, a plurality of second guide slots being formed on positions between adjacent heat dissipating fins respectively corresponding to the plurality of first guide slots; and
a lightbar device disposed on the heat dissipating structure, light generated by the lightbar device being emitted out of the first cover;
wherein liquid is drained out through at least one of the plurality of first guide slots and the corresponding second guide slot.

2. The lighting device of claim 1, wherein a guide channel is extendedly formed on the first guide slot or the second guide slot and communicated with the first guide slot and the second guide slot for guiding the flow of the liquid.

3. The lighting device of claim 1, wherein the heat dissipating structure further has at least one engaging member for engaging with an engaging structure on a support wall.

4. The lighting device of claim 3, wherein the engaging member is a T-shaped structure.

5. The lighting device of claim 1 further comprising:
a second cover connected to a side of the first cover and having a plurality of third guide slots formed on positions corresponding to the plurality of second guide slots, for covering the heat dissipating structure and the lightbar device cooperatively with the first cover;
wherein the liquid is drained out through at least one of the plurality of first guide slots, the corresponding second guide slot, and the corresponding third guide slot.

6. The lighting device of claim 5, wherein the heat dissipating structure further has at least one engaging member protruding from the second cover for engaging with an engaging structure on a support wall.

7. The lighting device of claim 5 further comprising:
at least one engaging member disposed on the second cover for engaging with an engaging structure on a support wall.

8. The lighting device of claim 5, wherein at least one liquid outlet is selectively formed at a bottom side of the first guide slot or the second guide slot for guiding draining out of the liquid.

9. The lighting device of claim 5 further comprising:
a support frame pivotally connected to the first cover or the second cover for supporting the first cover and the second cover on a holding surface.

10. The lighting device of claim 9, wherein the support frame is fixed to a support wall in a screw locking manner.

11. The lighting device of claim 1, wherein the heat dissipating structure further has a sealing chamber, and the lightbar device comprises:
at least one lightbar disposed on a front surface of the heat dissipating structure; and
a control circuit board electrically connected to the lightbar and disposed in the sealing chamber.

12. The lighting device of claim 11, wherein the lightbar comprises a plurality of light emitting diodes.
